(19) United States
(12) Patent Application Publication
(10) Pub. No.: US 2025/0034687 A1
(43) Pub. Date: Jan. 30, 2025

(54) HIGH-STRENGTH AND HIGH-HARDNESS REINFORCED WEAR-RESISTANT STEEL AND MANUFACTURING METHOD THEREFOR

(71) Applicant: BAOSHAN IRON & STEEL CO., LTD., Shanghai (CN)

(72) Inventors: Hongbin LI, Shanghai (CN); Jianhua DING, Shanghai (CN); Zicheng LIU, Shanghai (CN); Kougen WU, Shanghai (CN)

(73) Assignee: BAOSHAN IRON & STEEL CO., LTD., Shanghai (CN)

(21) Appl. No.: 18/706,895

(22) PCT Filed: Nov. 2, 2022
(86) PCT No.: PCT/CN2022/129272

§ 371 Date: May 2, 2024

(30) Foreign Application Priority Data
Nov. 3, 2021 (CN) 202111292512.6

(51) Int. Cl. C22C 38/58; C21D 8/02; C22C 38/00; C22C 38/02; C22C 38/06; C22C 38/44; C22C 38/46; C22C 38/48; C22C 38/50

(52) U.S. Cl. CPC C22C 38/58; C21D 8/0205; C21D 8/0226; C21D 8/0247; C22C 38/005; C22C 38/02; C22C 38/06; C22C 38/44; C22C 38/46; C22C 38/48; C22C 38/50; C21D 2211/001; C21D 2211/002; C21D 2211/008

(57) ABSTRACT

Disclosed in the present invention is high-strength and high-hardness reinforced wear-resistant steel, comprising Fe and inevitable impurities, and further comprising the following chemical elements in percentage by mass: C: 0.22-0.33%; Si: 0.10-1.00%; Mn: 0.50-1.80%; Cr: 0.80-2.30%; Al: 0.010-0.10%; RE: 0.01-0.10%; W: 0.01-1.0%; and at least one of MO: 0.01-0.80%, Ni: 0.01-1.00%, Nb: 0.005-0.080%, V: 0.01-0.20%, and Ti: 0.001-0.50%. In addition, further disclosed in the preset invention is a manufacturing method for the high-strength and high-hardness reinforced wear-resistant steel, comprising the steps of: (1) smelting and casting; (2) heating; (3) rolling; and (4) on-line quenching: wherein the cooling start temperature of primary cooling is (Ar3′+5)-(Ar3′+50)° C., M₉₀<final cooling temperature<Bs, and the cooling speed is 2-15° C./s; and then performing air-cooling to room temperature.

### TECHNICAL FIELD

The present disclosure relates to a steel product and a method for manufacturing the same, in particular to a wear-resistant steel and a method for manufacturing the same.

### BACKGROUND ART

Wear-resistant steel has the characteristics of high strength and high wear resistance. The wear-resistant steel has quite excellent performance and can be effectively used in the fields such as mining, agriculture, cement production, ports, electric power, metallurgy and the like for the manufacture of machinery products such as bulldozers, loaders, excavators, dump trucks and grabs, stackers and reclaimers, etc., with broad application prospects.

In recent years, the development and application of wear-resistant steel has developed rapidly, and the most commonly used one is martensitic wear-resistant steel. The mechanical performance of such wear-resistant steel is generally improved by increasing carbon content and adding an appropriate amount of alloying elements, such as chromium, molybdenum, nickel, vanadium, boron, etc., and making full use of phase transformation strengthening after heat treatment.

However, for the harsh working conditions, it is often necessary to use wear-resistant steel plates with very high hardness. The ultra-high strength and hardness of such wear-resistant steel lead to very high requirements for processing equipment in mechanical cutting, drilling, bending, etc. Since the mechanical processing is very difficult, it brings great difficulties to users.

Based on the above, in view of the deficiencies and defects of the existing wear-resistant steel, the present disclosure is expected to obtain a new high-strength, high-hardness reinforced wear-resistant steel, which has lower strength and hardness than the existing traditional ultra-high strength and hardness wear-resistant steel plate, and brings greater convenience to the user's mechanical processing. In actual use, the high-strength and high-hardness reinforced wear-resistant steel is prone to plasticity-induced phase transformation, which can significantly improve the strength and hardness of the steel plate, thereby improving the wear resistance of the steel plate. Through this effect, the mechanical properties and wear-resistant properties of the high-strength, high-hardness reinforced wear-resistant steel of the present disclosure are higher than those of the wear-resistant steel plate of the same hardness level in actual use.

### SUMMARY

One of the objects of the present disclosure is to provide a high-strength and high-hardness reinforced wear-resistant steel, which has excellent mechanical properties and also has excellent processability, thermal stability and welding performance at the same time. It realizes the matching of high strength and hardness and high toughness, has excellent processability, and has excellent mechanical properties and good wear resistance in actual use with very good promotion prospects and application value.

The high-strength and high-hardness reinforced wear-resistant steel involved in the present disclosure is easy to be processed. It not only provides convenience for conventional mechanical processing, but also can obtain excellent strength and toughness and wear resistance in use by plasticity-induced phase transformation. Due to its excellent performance, it can be popularized and applied on wear-resistant parts for construction machinery.

In order to realize the above purposes, the present disclosure provides a high-strength, high-hardness reinforced wear-resistant steel, which comprises Fe and unavoidable impurities, and further comprises the following chemical elements in mass percentages:

C: 0.22˜0.33%, Si: 0.10˜1.00%, Mn: 0.50˜1.80%, Cr: 0.80˜2.30%, Al: 0.010˜0.10%, RE: 0.01˜0.10%, W: 0.01˜1.0%; and at least one of Mo: 0.01˜0.80%, Ni: 0.01˜1.00%, Nb: 0.005˜0.080%, V: 0.01˜0.20%, and Ti: 0.001˜0.50%.

Further, the high-strength, high-hardness reinforced wear-resistant steel of the present disclosure comprises the following chemical elements in mass percentages:

C: 0.22˜0.33%, Si: 0.10˜1.00%, Mn: 0.50˜1.80%, Cr: 0.80˜2.30%, Al: 0.010˜0.10%, RE: 0.01˜0.10%, W: 0.01˜1.0%; and at least one of Mo: 0.01˜0.80%, Ni: 0.01˜1.00%, Nb: 0.005˜0.080%, V: 0.01˜0.20%, Ti: 0.001˜0.50%; with a balance of Fe and unavoidable impurities.

In the present disclosure, the high-strength and high-hardness reinforced wear-resistant steel is mainly added with C, Si elements and Mn, Cr alloying elements, and appropriately added with precious metal elements such as Mo and Ni as needed, which can control the low cost of the alloy while ensuring the performance of the steel.

For the high-strength, high-hardness reinforced wear-resistant steel of the present disclosure, the principles for designing the various chemical elements will be described in detail as follows:

C: in the high-strength, high-hardness reinforced wear-resistant steel of the present disclosure, C is the most basic and important element in wear-resistant steel. The addition of appropriate amount of C can improve the strength and hardness of the steel, thereby improving the wear resistance of the steel. However, it should be noted that C element will adversely affect the toughness and weldability of steel at the same time, so it is necessary to reasonably control the content of C element in the steel. Based on this, considering the influence of C content on the properties of wear-resistant steel, in the high-strength, high-hardness reinforced wear-resistant steel of the present disclosure, the mass percentage of C element is controlled at 0.22˜0.33%, preferably 0.23-0.28%. In some embodiments, the mass percentage of C element is 0.22˜0.31%. In some embodiments, the mass percentage of C element is 0.23˜0.31%. In some embodiments, the mass percentage of C element is 0.23˜0.30%.

Si: in the high-strength, high-hardness reinforced wear-resistant steel of the present disclosure, Si can be solidly dissolved in ferrite and austenite, thereby improving their hardness and strength. However, too high level of Si can also lead to a sharp decrease in the toughness of the steel. Meanwhile, considering that the affinity of Si element with O is stronger than that of Fe, it is easy to produce silicate with low melting point during welding, which increases the fluidity of slag and molten metal and affects the quality of welding line, so the content of Si element in the steel should not be too high. Therefore, in the high-strength, high-hardness reinforced wear-resistant steel of the present disclosure, the mass percentage of Si element is controlled at 0.10˜1.00%. In some embodiments, the mass percentage of Si element is 0.10˜0.80%. In some embodiments, the mass percentage of Si element is 0.15˜0.80%. In some embodiments, the mass percentage of Si element is 0.15˜0.65%.

Mn: in the high-strength, high-hardness reinforced wear-resistant steel of the present disclosure, the addition of an appropriate amount of Mn can strongly increase the hardenability of the steel and reduce the transition temperature of the steel and the critical cooling rate of the steel. However, it should be noted that the content of Mn element in the steel should not be too high. When the content of Mn element in the steel is too high, it not only tends to roughen the grain, but also increases the temper embrittlement sensitivity of the steel and easily leads to segregation and cracks in casting billets, which reduces the performance of the steel plate. Therefore, in the high-strength, high-hardness reinforced wear-resistant steel of the present disclosure, the mass percentage of Mn element is controlled at 0.50˜1.80%, preferably 1.05-1.65%. In some embodiments, the mass percentage of Mn element is 1.00˜1.80%. In some embodiments, the mass percentage of Mn element is 1.10˜1.80%. In some embodiments, the mass percentage of Mn element is 1.10˜1.80%. In some embodiments, the mass percentage of Mn element is 1.15˜1.80%. In some embodiments, the mass percentage of Mn element is 0.65˜1.65%.

Cr: in the high-strength, high-hardness reinforced wear-resistant steel of the present disclosure, the Cr element can reduce the critical cooling rate and improve the hardenability of the steel. Cr can form a variety of carbides such as (Fe, Cr)₃C, (Fe, Cr)₇C₃ and (Fe, Cr)₂₃C₇ in the steel, which can effectively improve the strength and hardness of the steel. In addition, it should be noted that the addition of an appropriate amount of Cr in the steel can prevent or slow down the precipitation and aggregation of carbides during tempering, thereby improving the tempering stability of the steel. Therefore, considering the beneficial effects of Cr element, in the high-strength, high-hardness reinforced wear-resistant steel of the present disclosure, the mass percentage of Cr element may be controlled at 0.80˜2.30%, preferably 1.25-2.10%. In some embodiments, the mass percentage of Cr element is 1.10˜2.20%. In some embodiments, the mass percentage of Cr element is 1.10˜2.00%. In some embodiments, the mass percentage of Cr element is 1.15˜2.00%. In some embodiments, the mass percentage of Cr element is 0.95˜2.10%.

Al: in the high-strength, high-hardness reinforced wear-resistant steel of the present disclosure, Al can form fine insoluble AlN particles with N in the steel, and refine the steel grain. The addition of an appropriate amount of Al in the steel can effectively refine the steel grain and fix N and O in the steel, thereby reducing the notch sensitivity of steel, reducing or eliminating the aging phenomenon of steel, and improving the toughness of steel. Therefore, in the high-strength, high-hardness reinforced wear-resistant steel of the present disclosure, the mass percentage of Al element is controlled at 0.010˜0.10%, preferably 0.035-0.080%. In some embodiments, the mass percentage of Al element is 0.010˜0.080%. In some embodiments, the mass percentage of Al element is 0.015˜0.075%. In some embodiments, the mass percentage of Al element is 0.015˜0.070%. In some embodiments, the mass percentage of Al element is 0.025˜0.080%.

RE: in the high-strength, high-hardness reinforced wear-resistant steel of the present disclosure, the addition of an appropriate amount of rare earths can reduce the segregation of sulfur, phosphorus and other elements, improve the shape, size and distribution of non-metallic inclusions, and at the same time refine the grain and improve the hardness. In addition, rare earths can also improve the yield ratio, which is conducive to improving the strength and toughness of low-alloy high-strength steels, and can improve the thermal stability of steel plates. However, it should be noted that the content of rare earths in the steel should not be too high. Otherwise, serious segregation will occur, which will reduce the quality and mechanical properties of the casting billet. Therefore, in the high-strength, high-hardness reinforced wear-resistant steel of the present disclosure, the mass percentage of RE is controlled at 0.01˜0.10%, preferably 0.03-0.10%. In some embodiments, the mass percentage of RE is 0.025˜0.080%.

W: in the high-strength, high-hardness reinforced wear-resistant steel of the present disclosure, tungsten can increase the tempering stability and thermal strength of steel, and can play a certain role in refining grains. In addition, tungsten can also form hard carbides to increase the wear resistance of steel. Therefore, in order to bring out the beneficial effects of tungsten, in the high-strength, high-hardness reinforced wear-resistant steel of the present disclosure, the mass percentage of W element is controlled at 0.01˜1.0%, preferably 0.05-0.85%. In some embodiments, the mass percentage of W is 0.05˜0.85%.

Mo: in the high-strength, high-hardness reinforced wear-resistant steel of the present disclosure, the addition of an appropriate amount of Mo can effectively refine the grains and improve the strength and toughness of the steel. Due to the presence of Mo in the solid solution phase and carbide phase in the steel, Mo-containing steel has the effect of solution strengthening and carbide diffusion strengthening at the same time. In addition, Mo is also an element that can reduce temper embrittlement. The addition of an appropriate amount of Mo in the steel can also improve the tempering stability of the material. Therefore, in the high-strength and high-hardness reinforced wear-resistant steel of the present disclosure, when added, the mass percentage of the Mo element is controlled at 0.01˜0.80%, preferably 0.08˜0.55%.

Ni: in the high-strength, high-hardness reinforced wear-resistant steel of the present disclosure, Ni can be miscible with Fe in any ratio and improve the low-temperature toughness of steel by refining ferrite grains, and has the effect of significantly reducing the ductile-brittle transition temperature. However, it should be noted that the Ni content in the steel should not be too high. When the Ni content in the steel is too high, it is easy to cause the oxide scale on the surface of the steel plate to be difficult to fall off, thereby significantly increasing the production cost. Therefore, in the high-strength and high-hardness reinforced wear-resistant steel of the present disclosure, when added, the mass percentage of the Ni element is controlled at 0.01˜1.00%, preferably 0.25˜0.85%.

Nb: in the high-strength, high-hardness reinforced wear-resistant steel of the present disclosure, the addition of an appropriate amount of Nb can play a role in grain refinement and precipitation strengthening, which makes a significant contribution to improving the strength and toughness of the material. Nb can effectively improve the strength and toughness of steel by grain refinement, and it can also increase and improve the properties of steel by precipitation strengthening and phase change strengthening, and Nb has become one of the most effective reinforcing agents in high-strength low-alloy structural steel. In addition, Nb is also a strong carbide or nitride-forming element, which can strongly inhibit the growth of austenite grain. Therefore, in the high-strength and high-hardness reinforced wear-resistant steel of the present disclosure, when added, the mass percentage of the Nb element is controlled at 0.005˜0.080%, preferably 0.01˜0.045%.

V: in the high-strength, high-hardness reinforced wear-resistant steel of the present disclosure, the addition of an appropriate amount of V element can effectively refine the grains, so that the austenite grains will not grow too coarse in the heating stage of the billet. Thus, the grains of the steel can be further refined in the subsequent multi-pass rolling process, so that the strength and toughness of the steel can be improved. Therefore, in the high-strength and high-hardness reinforced wear-resistant steel of the present disclosure, when added, the mass percentage of the V element is controlled at 0.01˜0.20%, preferably 0.03˜0.15%.

Ti: in the high-strength, high-hardness reinforced wear-resistant steel of the present disclosure, Ti is one of the strong carbide-forming elements, and Ti can combine with C to form fine TiC particles. The TiC particles are small and can be distributed in the grain boundaries, so as to achieve the effect of refining the grains. In addition, TiC particles are harder, which can improve the wear resistance of steel. Therefore, considering the beneficial effect of Ti, in the high-strength and high-hardness reinforced wear-resistant steel of the present disclosure, when added, the mass percentage of the Ti element is controlled at 0.001˜0.50%, preferably 0.015˜0.45%.

Further, preferably, the high-strength, high-hardness reinforced wear-resistant steel of the present disclosure comprises the following chemical elements in mass percentages: C: 0.22˜0.31%, Si: 0.10˜0.80%, Mn: 1.00˜1.80%, Cr: 1.10˜2.20%, Al: 0.010˜0.080%.

Further, more preferably, the high-strength, high-hardness reinforced wear-resistant steel of the present disclosure comprises the following chemical elements in mass percentages: C: 0.23˜0.31%, Si: 0.15˜0.80%, Mn: 1.10˜1.80%, Cr: 1.10˜2.00%, Al: 0.015˜0.075%.

Most preferably, the high-strength, high-hardness reinforced wear-resistant steel of the present disclosure comprises the following chemical elements in mass percentages: C: 0.23˜0.30%, Si: 0.15˜0.65%, Mn: 1.15˜1.80%, Cr: 1.15˜2.00%, Al: 0.015˜0.070%.

Further, in the high-strength, high-hardness reinforced wear-resistant steel of the present disclosure, in the above unavoidable impurities, P is ≤0.030%, and/or S is ≤0.010%.

In the present disclosure, both P and S are unavoidable impurities. If the technical conditions permit, in order to ensure the quality of the wear-resistant steel, the amount of impurity elements in the steel should be minimized. P and S are both harmful elements, and their contents should be strictly controlled. Therefore, in the high-strength, high-hardness reinforced wear-resistant steel of the present disclosure, the unavoidable impurity elements can be controlled to satisfy: P≤0.030%, and/or S≤0.010%.

Further, the high-strength, high-hardness reinforced wear-resistant steel of the present disclosure has a microstructure of martensite+bainite+residual austenite+carbide.

Further, in the high-strength, high-hardness reinforced wear-resistant steel of the present disclosure, the volume fraction of residual austenite is equal to or greater than 5%, and the volume fraction of martensite is equal to or less than 90%. In some embodiments, in the high-strength, high-hardness reinforced wear-resistant steel of the present disclosure, the volume fraction of residual austenite is 5˜15%, and the volume fraction of martensite is 65˜90%. In some embodiments, in the high-strength, high-hardness reinforced wear-resistant steel of the present disclosure, the volume fraction of residual austenite is 5.3˜12.0%, such as 5.5˜8.5%, and the volume fraction of martensite is 70˜88%, such as 77.5-85.6%.

Compared with the conventional low-alloy steel plate with the same hardness level, the microstructure of the high-strength and high-hardness reinforced wear-resistant steel of the present disclosure is different from the currently-prevailing martensite structure, and it forms the microstructure of martensite+bainite+residual austenite+carbide.

Based on the above microstructure, the mechanical properties of the high-strength and high-hardness reinforced wear-resistant steel of the present disclosure can be ensured. The strength and hardness of the high-strength and high-hardness reinforced wear-resistant steel are slightly lower. It is more convenient to the user's mechanical processing and is suitable for easy processing.

In addition, in actual use, the high-strength and high-hardness reinforced wear-resistant steel of the present disclosure has extremely excellent wear resistance, which is mainly due to the TRIP (phase change-induced plasticity) effect that occurs in the use process. That is, because the steel plate contains a certain amount of martensite or bainite in addition to a certain proportion of austenite, plasticity-induced phase transformation occurs when the steel plate is subjected to impact, pressure, and wear during use, which can significantly improve the strength and hardness of the steel plate, thereby improving the wear resistance of the steel plate. Through this effect, the mechanical properties and wear resistance of the high-strength, high-hardness reinforced wear-resistant steel of the present disclosure can be higher than that of the conventional wear-resistant steel plate of the same hardness level in actual use.

In addition, it should be noted that, because the high-strength, high-hardness reinforced wear-resistant steel of the present disclosure has a special microstructure, as well as the RE and W elements added, it can also obtain a certain high temperature resistance. At higher temperatures, the loss of strength and hardness of the steel plate is not large.

Further, the high-strength, high-hardness reinforced wear-resistant steel of the present disclosure has a Brinell hardness of 400˜500 HBW, a tensile strength of 1200˜1600 MPa (such as 1300˜1600 MPa), an elongation of 10˜15%, and a Charpy V-notch longitudinal impact energy at −40° C. of >40 J.

In some embodiments, the high-strength, high-hardness reinforced wear-resistant steel of the present disclosure has a Brinell hardness of 420˜480 HBW, a tensile strength of 1220˜1450 MPa, an elongation of 10˜15%, and a Charpy V-notch longitudinal impact energy at −40° C. of >40 J, such as 41˜60 J.

In some embodiments, the high-strength, high-hardness reinforced wear-resistant steel of the present disclosure has a yield strength of 800˜1000 MPa, such as 830˜980 MPa. In some embodiments, the high-strength, high-hardness reinforced wear-resistant steel of the present disclosure has a yield strength ratio of ≤0.75, preferably ≤0.70.

In some embodiments, after the high-strength and high-hardness reinforced wear-resistant steel of the present disclosure is subjected to 550 J impact energy blow, the Brinell hardness of the surface of the steel plate is measured to be more than 10% higher than the Brinell hardness of the steel plate before the test, preferably more than 13% higher. In some embodiments, after the high-strength, high-hardness reinforced wear-resistant steel of the present disclosure is subjected to 550 J impact energy blow, the Brinell hardness of the surface of the steel plate is ≥480 HBW, such as 480˜560 HBW.

Accordingly, another object of the present disclosure provides a manufacturing method for the high-strength and high-hardness reinforced wear-resistant steel. The manufacturing method is simple and feasible, and the comprehensive properties of the high-strength, high-hardness reinforced wear-resistant steel prepared by this manufacturing method are extremely good. The steel has a Brinell hardness of 400˜500 HBW, a tensile strength of 1200˜1600 MPa (such as 1300˜1600 MPa), an elongation of 10˜15%, and a Charpy V-notch longitudinal impact energy at −40° C. of >40 J with very good promotion prospects and application value.

To achieve the above purpose, the present disclosure provides a manufacturing method for the above high-strength and high-hardness reinforced wear-resistant steel, comprising steps of:
(1) smelting and casting;
(2) heating;
(3) rolling;
(4) on-line quenching: wherein an initial cooling temperature for primary cooling is: (Ar3′+5)˜(Ar3′+50)° C., M₉₀<a final cooling temperature<Bs, and a cooling rate is 2˜15° C./s; then performing air cooling to room temperature.

In the manufacturing method for the high-strength and high-hardness reinforced wear-resistant steel of the present disclosure, each raw material for smelting is added according to the chemical composition ratio designed by the inventor, and the high-strength, high-hardness reinforced wear-resistant steel can be obtained after smelting, casting, heating, rolling and on-line quenching steps in sequence.

It should be noted that, in the online quenching procedure of the above step (4) of the present disclosure, the primary cooling may be water cooling or oil cooling.

In the present disclosure, Ar3′ represents the temperature at which the austenite starts to transform to ferrite during the on-line quenching procedure of the steel; Bs represents the temperature at which the bainite starts to transform; M₉₀ represents a temperature at which the volume fraction of martensite is 90%.

Further, in the manufacturing method of the present disclosure, in Step (2), a heating temperature for making a slab is 1030˜1230° C., and a holding time is 1-3 hours. In some embodiments, the heating temperature for making a slab is 1050˜1210° C., and the holding time is 1-3 hours.

Further, in the manufacturing method of the present disclosure, in Step (2), the slab heating temperature is controlled at 1030˜1180° C.

Accordingly, in some other embodiments, more preferably, the heating temperature may be controlled at 1030-1160° C. In order to improve production efficiency and prevent excessive growth of austenite grains and serious oxidation on billet surface, most preferably, the heating temperature may be controlled at 1030-1140° C.

Further, in the manufacturing method of the present disclosure, in Step (3), a rough rolling temperature is 930˜1180° C., and a finish rolling temperature is 870˜970° C. In some embodiments, in Step (3), the rough rolling temperature is controlled at 950˜1150° C., and the finish rolling temperature is 885˜955° C.

Further, in the manufacturing method of the present disclosure, in Step (3), the rough rolling temperature is controlled at 930˜1130° C., and the finish rolling temperature is controlled at 875˜945° C.

Further, in the manufacturing method of the present disclosure, in Step (3), a rolling reduction ratio in the rough rolling stage is controlled at more than 35%, and a rolling reduction ratio in the finish rolling stage is controlled at more than 55%. Further, in the manufacturing method of the present disclosure, in Step (3), the rolling reduction ratio in the rough rolling stage is controlled at 35˜75%, and the rolling reduction ratio in the finish rolling stage is controlled at 55˜80%.

In some other embodiments, in order to obtain better implementation effects, preferably, the rough rolling temperature is controlled at 930-1110° C., the rolling reduction ratio in the rough rolling stage is controlled at more than and equal to 38%, the finish rolling temperature is controlled at 875˜935° C. and the rolling reduction ratio in the finish rolling stage is controlled at more than and equal to 58%.

Most preferably, in the rolling procedure of Step (3), the rough rolling temperature is controlled at 935-1105° C., the rolling reduction ratio in the rough rolling stage is controlled at more than 40%, the finish rolling temperature is controlled at 875˜930° C. and the rolling reduction ratio in the finish rolling stage is controlled at more than 60%.

Further, in the manufacturing method of the present disclosure, in Step (4), an initial cooling temperature for the primary cooling is (Ar3′+5)˜(Ar3′+45)° C., (M₉₀+5° C.)<a final cooling temperature<(Bₛ−15° C.), and a cooling rate is 2˜12° C./s.

In some other embodiments, more preferably, the initial cooling temperature for the primary cooling is controlled at (Ar3′+5)˜(Ar3′+40)° C., the finial cooling temperature is controlled to satisfy: (M₉₀+5° C.)<the final cooling temperature<(Bₛ−20° C.), and the cooling rate is controlled at 2-11° C./s.

Most preferably, the initial cooling temperature for the primary cooling is controlled at (Ar3′+5)˜(Ar3′+38)° C., the finial cooling temperature is controlled to satisfy: (M₉₀+5° C.)<the final cooling temperature<(Bₛ−23° C.), and the cooling rate is controlled at 3-11° C./s.

In some embodiments, the final cooling temperature is controlled at 350˜450° C.

In some embodiments, the thickness of the high-strength and high-hardness reinforced wear-resistant steel of the present disclosure is 9˜25 mm.

Compared with the prior art, the high-strength and high-hardness reinforced wear-resistant steel of the present disclosure and the manufacturing method therefor have the advantages and beneficial effects below:
(1) In the chemical composition design, the alloy composition of the high-strength, high-hardness reinforced wear-resistant steel of the present disclosure is fully optimized, which is mainly added with C, Si elements and Mn, Cr alloying elements, and appropriately added with precious metal elements such as Mo and Ni as needed, so as to control the low cost of the alloy while ensure the performance of the steel.
(2) in view of the microstructure, the high-strength and high-hardness reinforced wear-resistant steel of the present disclose can realize the microstructure of martensite+bainite+residual austenite+carbide (wherein the volume fraction of the martensite is <90%, the volume fraction of the residual austenite is >5%, with a balance of bainite and carbides), resulting in the TRIP effect of the steel plate in use, so that the strength and hardness and wear resistance of the steel plate are improved, thereby improving the utility and service life of the steel plate. In addition, a large number of hard phases, such as Ti, Cr, Mo and W carbides are evenly distributed and can further improve the wear resistance and service life of the steel plate.
(3) compared with the existing conventional martensitic wear-resistant steel, the high-strength, high-hardness reinforced wear-resistant steel of the present disclosure has relatively low strength and hardness. It is more convenient to the user's mechanical processing and suitable for easy processing. In addition, due to the addition of RE and W elements, the high-strength, high-hardness reinforced wear-resistant steel of the present disclosure also has a certain high temperature resistance. At higher temperatures, the loss of strength and hardness of the steel plate is not great.

To sum up, it can be seen that, in the present disclosure, the carbon and alloy composition and the ratio thereof are scientifically designed under reasonable production process conditions to reduce the alloy cost. The manufacturing method is simple and feasible, and conducive to industrial production. Correspondingly, the high-strength, high-hardness reinforced wear-resistant steel of the present disclosure has excellent mechanical properties (such as hardness, strength, elongation, impact toughness and certain high temperature resistance), but also has good processability and usability. It has a Brinell hardness of 400˜500 HBW, a tensile strength of 1200˜1600 MPa (such as 1300˜1600 MPa), an elongation of 10˜15%, and a Charpy V-notch longitudinal impact energy at −40° C. of >40 J with very good promotion prospects and application value.

### DESCRIPTION OF THE DRAWINGS

FIG. 1 is a photograph of the metallographic structure of the high-strength, high-hardness reinforced wear-resistant steel prepared in Example 3.

### DETAILED DESCRIPTION

The high-strength and high-hardness reinforced wear-resistant steel and the manufacturing method therefor will be further explained and described below in combination with specific embodiments, but the interpretation and explanation do not constitute an undue limitation to the technical solution of the present disclosure.

### Example 1-8

The high-strength, high-hardness reinforced wear-resistant steel of Examples 1-8 were prepared by the following steps:
(1) Smelting and casting were performed according to the chemical compositions shown in Table 1.
(2) Heating: the obtained slab was heated, wherein the slab heating temperature was controlled at 1030˜1230° C. and held for 1-3 hours. Certainly, the slab heating temperature may also be preferably controlled at 1030˜1180° C.
(3) Rolling: the slab after heating was subjected to rolling, wherein the rough rolling temperature was controlled at 930˜1180° C., the finish rolling temperature was controlled at 870˜970° C., the rolling reduction ratio in the rough rolling stage was controlled at more than 35%, and the rolling reduction ratio in the finish rolling stage was controlled at more than 55%. Certainly, when the rolling reduction ratio in the rough rolling stage was controlled at more than 35% and the rolling reduction ratio in the finish rolling stage was controlled at more than 55%, the rough rolling temperature may also be preferably controlled at 930˜1130° C. and the finish rolling temperature may be preferably controlled at 875˜945° C.
(4) On-line quenching: wherein the initial cooling temperature for the primary cooling was controlled at (Ar3′+5)˜(Ar3′+50)° C., M₉₀<the final cooling temperature<Bs, the cooing rate was 2˜15° C./s, then the steel was air cooled to room temperature. Certainly, the initial cooling temperature for the primary cooling may also be preferably controlled at (Ar3′+5)˜(Ar3′+45)° C., the finial cooling temperature may be preferably controlled to satisfy: (M₉₀+5° C.)<the final cooling temperature<(Bₛ−15° C.), and the cooling rate may be preferably controlled at 2˜12° C./s.

It should be noted that the high-strength and high-hardness reinforced wear-resistant steel of Examples 1-8 were all prepared by the above steps. The chemical composition and the related process parameters all met the design specification control requirements of the present disclosure.

Table 1 lists the mass percentages of the various chemical elements in the high-strength and high-hardness reinforced wear-resistant steel of Examples 1-8.

TABLE 1
(wt %, a balance of Fe and other unavoidable impurities except P and S)

| | Chemical element | | | | | | | | | | | | | |
|---|---|---|---|---|---|---|---|---|---|---|---|---|---|---|
| No. | C | Si | Mn | P | S | Cr | Mo | Ni | RE | W | Nb | V | Al | Ti |
| Ex. 1 | 0.22 | 0.65 | 1.65 | 0.010 | 0.003 | 1.65 | 0.08 | — | 0.05 | 0.35 | 0.045 | 0.05 | 0.035 | — |
| Ex. 2 | 0.24 | 0.40 | 1.35 | 0.011 | 0.003 | 2.10 | — | — | 0.10 | 0.85 | 0.015 | 0.15 | 0.045 | 0.015 |
| Ex. 3 | 0.26 | 0.35 | 1.20 | 0.009 | 0.003 | 1.40 | — | 0.25 | 0.04 | 0.10 | — | — | 0.080 | — |
| Ex. 4 | 0.27 | 0.30 | 1.15 | 0.011 | 0.003 | 1.55 | 0.55 | — | 0.08 | 0.35 | — | 0.08 | 0.055 | 0.41 |
| Ex. 5 | 0.28 | 0.15 | 1.05 | 0.010 | 0.002 | 1.25 | — | 0.85 | 0.03 | 0.20 | — | — | 0.050 | 0.15 |
| Ex. 6 | 0.29 | 0.20 | 0.75 | 0.010 | 0.002 | 1.60 | 0.30 | — | 0.05 | 0.05 | 0.010 | — | 0.040 | — |
| Ex. 7 | 0.31 | 0.25 | 0.80 | 0.008 | 0.002 | 1.35 | 0.10 | 0.65 | 0.06 | 0.25 | — | 0.03 | 0.035 | — |
| Ex. 8 | 0.33 | 0.30 | 0.65 | 0.008 | 0.002 | 0.95 | 0.15 | 0.35 | 0.03 | 0.30 | 0.015 | — | 0.025 | 0.25 |

Table 2-1 and Table 2-2 list the specific process parameters in each step of the above manufacturing method for the high-strength and high-hardness reinforced wear-resistant steel of Examples 1-8.

TABLE 2-1

| | | | Step (3) | | | |
|---|---|---|---|---|---|---|
| | Step (2) | | | Rolling | | Rolling |
| | Slab | Holding | Rough | reduction ratio | Finish | reduction ratio |
| | heating | time for | rolling | in the rough | rolling | in the finish |
| | temperature | slab heating | temperature | rolling stage | temperature | rolling stage |
| No. | (° C.) | (h) | (° C.) | (%) | (° C.) | (%) |
| Ex. 1 | 1145 | 2.5 | 1075 | 49 | 905 | 58 |
| Ex. 2 | 1150 | 2.5 | 1085 | 38 | 920 | 63 |
| Ex. 3 | 1210 | 1.5 | 1150 | 55 | 955 | 72 |
| Ex. 4 | 1165 | 2 | 1090 | 62 | 920 | 75 |
| Ex. 5 | 1170 | 2 | 1080 | 58 | 915 | 60 |
| Ex. 6 | 1110 | 3 | 975 | 71 | 910 | 71 |
| Ex. 7 | 1050 | 3 | 950 | 53 | 885 | 66 |
| Ex. 8 | 1185 | 3 | 1100 | 64 | 925 | 78 |

TABLE 2-2

| | Step (4) | | | | | Thickness |
|---|---|---|---|---|---|---|
| | Initial | | Final | | | of the |
| | cooling | Cooling | cooling | | | finished |
| | temperature | rate | temperature | Bs | M₉₀ | steel plate |
| No. | (° C.) | (° C./s) | (° C.) | (° C.) | (° C.) | (mm) |
| Ex. 1 | Ar3′ + 10 | 12 | 361 | 545 | 341 | 25 |
| Ex. 2 | Ar3′ + 15 | 15 | 371 | 531 | 356 | 19 |
| Ex. 3 | Ar3′ + 30 | 8 | 425 | 562 | 367 | 20 |
| Ex. 4 | Ar3′ + 15 | 6 | 436 | 552 | 345 | 10 |
| Ex. 5 | Ar3′ + 35 | 5 | 426 | 541 | 361 | 9 |
| Ex. 6 | Ar3′ + 40 | 11 | 395 | 546 | 359 | 16 |
| Ex. 7 | Ar3′ + 10 | 7 | 415 | 552 | 346 | 12 |
| Ex. 8 | Ar3′ + 25 | 9 | 426 | 553 | 355 | 17 |

Note: in Table 2-2, Ar3′ represented the temperature at which the austenite starts to transform to ferrite during the on-line quenching procedure of the test steel; Bs represented the temperature at which the bainite starts to transform; M₉₀ represented a temperature at which the volume fraction of martensite is 90%.

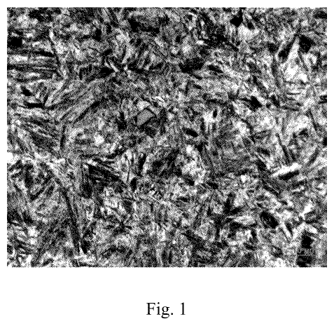

The high-strength and high-hardness reinforced wear-resistant steel as prepared in Examples 1-8 was sampled separately, and the high-strength and high-hardness reinforced wear-resistant steel samples of Examples 1-8 were observed and analyzed. It was found that the microstructure of the high-strength and high-hardness reinforced wear-resistant steel of Examples 1-8 was martensite+bainite+residual austenite+carbide. The metallographic structure photograph of Example 3 was shown in FIG. 1.

Correspondingly, the microstructure of the high-strength and high-hardness reinforced wear-resistant steel of Examples 1-8 was further analyzed to determine the volume fraction of the residual austenite structure and the volume fraction of the martensite structure, wherein the volume fractions of the residual austenite were all >5%, the volume fractions of martensite were all <90%. The results of the volume fraction of the residual austenite structure were listed in Table 3 below.

TABLE 3

| | Volume | | |
|---|---|---|---|
| | fraction of | Volume | |
| | residual | fraction of | |
| Example | austenite | martensite | note |
| Ex. 1 | 5.6 | 85.6 | a balance of bainite + carbide |
| Ex. 2 | 7.5 | 79.2 | a balance of bainite + carbide |
| Ex. 3 | 8.3 | 77.5 | a balance of bainite + carbide |
| Ex. 4 | 6.2 | 83.1 | a balance of bainite + carbide |
| Ex. 5 | 6.6 | 83.8 | a balance of bainite + carbide |
| Ex. 6 | 7.1 | 81.8 | a balance of bainite + carbide |
| Ex. 7 | 5.9 | 85.0 | a balance of bainite + carbide |
| Ex. 8 | 7.5 | 81.3 | a balance of bainite + carbide |

Referring to the above Table 3, it can be seen that in the present disclosure, the volume fraction of the residual austenite of the high-strength and high-hardness reinforced wear-resistant steel of Examples 1-8 was between 5.6% and 8.3%.

After the completion of the microstructure observation of the high-strength and high-hardness reinforced wear-resistant steel of Examples 1-8 of the present disclosure, the mechanical properties of the high-strength and high-hardness reinforced wear-resistant steel sample of Examples 1-8 were further tested to obtain the mechanical performance parameters of the high-strength and high-hardness reinforced wear-resistant steel of Examples 1-8. The obtained test results were listed in Table 4 below.

The relevant mechanical performance test methods are as follows:

Tensile test: the tensile performance test was carried out according to the GB/T 228.1 standard by using SCL233200 kN normal temperature tensile testing machine at room temperature, so as to measure the tensile strength and elongation at room temperature of the high-strength, high-hardness reinforced wear-resistant steel sample in Examples 1-8.

Cold bending test: the bending test was carried out on the high-strength and high-hardness reinforced wear-resistant steel of Examples 1-8 respectively at room temperature to obtain the corresponding results. YJW-2000 electro-hydraulic servo bending testing machine was used at room temperature to carry out the bending test according to GB/T 232 standard. After the bending test, no magnifying instrument was used for observation. If no visible crack was observed on the outer surface of the sample, it was assessed as “qualified”.

Brinell hardness test: the Brinell hardness test was carried out with SCL246 Brinell hardness testing machine at room temperature according to the GB/T 231.1 standard. The hardness test was carried out on the surface position of the high-strength and high-hardness reinforced wear-resistant steel samples of Examples 1-8 respectively to obtain the Brinell hardness of the corresponding Example.

After the Brinell hardness of the high-strength and high-hardness reinforced wear-resistant steel samples of Examples 1-8 was obtained, the Brinell hardness of the steel plate surface was measured by using a self-made drop weight device after the same 550 J impact energy blow on the steel plate of each Example, so as to obtain the reinforced Brinell hardness.

Impact test: the impact performance test was carried out with SCL186750 J instrumented impact testing machine at −40° C. according to the GB/T 229 standard. The impact toughness of the high-strength and high-hardness reinforced wear-resistant steel samples in Examples 1-8 was tested respectively to obtain the corresponding impact energy.

Table 4 lists the mechanical performance test results at the surface position of the high-strength, high-hardness reinforced wear-resistant steel of Examples 1-8.

TABLE 4

| | | | | | | | Charpy V-notch |
|---|---|---|---|---|---|---|---|
| | | | Hardness | Yield | Tensile | | longitudinal |
| | 90° cold | Brinell | after | strength | strength | Elongation | impact energy |
| | bending | hardness | reinforcement | Rp0.2 | Rm | A | at −40° C. |
| Example | D = 3a | (HBW) | (HBW) | (MPa) | (MPa) | (%) | (J) |
| Ex. 1 | qualified | 422 | 493 | 835 | 1240 | 15 | 57 |
| Ex. 2 | qualified | 435 | 509 | 850 | 1275 | 14 | 55 |
| Ex. 3 | qualified | 456 | 528 | 945 | 1365 | 14 | 52 |
| Ex. 4 | qualified | 475 | 545 | 980 | 1415 | 13 | 46 |
| Ex. 5 | qualified | 465 | 536 | 965 | 1395 | 12 | 42 |
| Ex. 6 | qualified | 472 | 541 | 970 | 1405 | 13 | 43 |
| Ex. 7 | qualified | 461 | 535 | 950 | 1380 | 12 | 45 |
| Ex. 8 | qualified | 455 | 528 | 955 | 1365 | 12 | 44 |

Note: Hardness after reinforcement is the Brinell hardness on the surface of the steel plate measured by a self-made drop weight device after 550 J impact energy blow on the steel plate of the sample.

Referring to the above table 4, it can be seen that the high-strength and high-hardness reinforced wear-resistant steel sample of Examples 1-8 of the present disclosure has very excellent mechanical properties. It not only has the characteristics of high strength, high hardness, high elongation, etc., but also has excellent low-temperature impact toughness. The yield strength is 835-980 MPa, the tensile strength is 1240-1415 MPa, and the elongation is 12-15%, the surface Brinell hardness is 422-475 HBW, and the Charpy V-notch longitudinal impact energy at −40° C. is 42-57 J.

The high-strength and high-hardness reinforced wear-resistant steel of Examples 1-8 of the present disclosure still had a good Brinell hardness after reinforcement. After 550 J impact energy blow on the specimen steel plate was carried out with the self-made drop weight device, the Brinell hardness of the reinforced steel plate of each Example was measured to be 493-545 HBW.

Correspondingly, the high-strength and high-hardness reinforced wear-resistant steel of Examples 1-8 of the present disclosure all have very excellent cold-bending performance. There are no visible cracks on the outer surface of the sample after the bending test, and the samples are all “qualified”. Because the yield strength of the steel plate of the present disclosure is very low compared with the conventional wear-resistant steel of the same hardness level, the forming processability of the steel plate such as bending is very good.

Based on the above, it can be seen that the high-strength and high-hardness reinforced wear-resistant steel of the present disclosure is based on a reasonable chemical element composition design and an optimized process and the wear-resistant steel having a microstructure of martensite+bainite+residual austenite+carbide can be obtained. The high-strength, high-hardness reinforced wear-resistant steel not only has excellent mechanical properties (such as hardness, strength, elongation, impact toughness and certain high temperature resistance), but also has good processability and usability.

The high-strength and high-hardness reinforced wear-resistant steel of the present disclosure is easy to be processed. It not only provides convenience for conventional machining, but also can have excellent strength and toughness and wear resistance in use and can be popularized and applied on the wear-resistant parts for construction machinery.

It should be noted that the prior art part of the protection scope of the present disclosure is not limited to the embodiments provided herein, and all prior arts that do not contradict the solution of the present disclosure, including but not limited to prior patent documents, prior published publications, prior public use, etc., can be included in the protection scope of the present disclosure.

The combination of the technical features in the present disclosure is not limited to the combination described in the claims or the specific embodiments, and all the technical features recorded herein may be freely combined or combined in any way, unless there is a contradiction between them.

It should also be noted that the examples listed above are only specific embodiments of the present disclosure. Obviously, the present disclosure is not limited to the above embodiments, and similar changes or modifications made thereby are directly derived from the contents disclosed in the present disclosure or easily envisaged by those skilled in the art, and shall fall within the protection scope of the present disclosure.

1. A high-strength, high-hardness reinforced wear-resistant steel comprising Fe and unavoidable impurities, wherein it further comprises the following chemical elements in mass percentages:
C: 0.22˜0.33%, Si: 0.10˜1.00%, Mn: 0.50˜1.80%, Cr: 0.80˜2.30%, Al: 0.010˜0.10%, RE: 0.01˜0.10%, W: 0.01˜1.0%; and at least one of Mo: 0.01˜0.80%, Ni: 0.01˜1.00%, Nb: 0.005˜0.080%, V: 0.01˜0.20%, Ti: 0.001˜0.50%.

2. The high-strength, high-hardness reinforced wear-resistant steel according to claim 1, wherein it comprises the following chemical elements in mass percentages:
C: 0.22˜0.33%, Si: 0.10˜1.00%, Mn: 0.50˜1.80%, Cr: 0.80˜2.30%, Al: 0.010˜0.10%, RE: 0.01˜0.10%, W: 0.01˜1.0%; and at least one of Mo: 0.01˜0.80%, Ni: 0.01˜1.00%, Nb: 0.005˜0.080%, V: 0.01˜0.20%, Ti: 0.001˜0.50%; with a balance of Fe and unavoidable impurities.

3. The high-strength, high-hardness reinforced wear-resistant steel according to claim 1, wherein the mass percentage of each chemical element satisfies: C: 0.22˜0.31%, Si: 0.10˜0.80%, Mn: 1.00˜1.80%, Cr: 1.10˜2.20%, Al: 0.010˜0.080%; or the mass percentage of each chemical element satisfies: C: 0.23˜0.31%, Si: 0.15˜0.80%, Mn: 1.10˜1.80%, Cr: 1.10˜2.00%, Al: 0.015˜0.075%; or the mass percentage of each chemical element satisfies: C: 0.23˜0.30%, Si: 0.15˜0.65%, Mn: 1.15˜1.80%, Cr: 1.15˜2.00%, Al: 0.015˜0.070%.

4. The high-strength, high-hardness reinforced wear-resistant steel according to claim 1, wherein the mass percentage of the chemical elements has one or more of the following features: the content of C is 0.23˜0.28%; the content of Si is 0.15˜0.65%; the content of Mn is 1.05˜1.65%; the content of Cr is 1.25˜2.10%; and the content of Al is 0.035˜0.080%.

5. The high-strength, high-hardness reinforced wear-resistant steel according to claim 1, wherein, in the unavoidable impurities, P is ≤0.030%, and/or S is ≤0.010%.

6. The high-strength, high-hardness reinforced wear-resistant steel according to claim 1, wherein it has a microstructure of martensite+bainite+residual austenite+carbide.

7. The high-strength, high-hardness reinforced wear-resistant steel according to claim 1, wherein the volume fraction of residual austenite is ≥5%, and the volume fraction of martensite is ≤90%.

8. The high-strength, high-hardness reinforced wear-resistant steel according to claim 1, wherein it has a Brinell hardness of 400˜500 HBW, a tensile strength of 1200˜1600 MPa, an elongation of 10˜15%, and a Charpy V-notch longitudinal impact energy at −40° C. of >40 J.

9. A manufacturing method for the high-strength and high-hardness reinforced wear-resistant steel according to claim 1, which comprises steps of:
(1) smelting and casting;
(2) heating;
(3) rolling;
(4) on-line quenching: wherein an initial cooling temperature for primary cooling is: (Ar3′+5)˜(Ar3′+50)° C., M₉₀<a final cooling temperature<Bs, and a cooling rate is 2˜15° C./s; then preforming air cooling to room temperature.

10. The manufacturing method according to claim 9, wherein in step (2), a slab heating temperature is controlled at 1030˜1230° C. and held for 1-3 hours

11. The manufacturing method according to claim 10, wherein in step (2), the slab heating temperature is controlled at 1030˜1180° C.

12. The manufacturing method according to claim 9, wherein in Step (3), a rough rolling temperature is controlled at 930˜1180° C., and a finish rolling temperature is controlled at 870˜970° C.

13. The manufacturing method according to claim 12, wherein in Step (3), the rough rolling temperature is controlled at 930˜1130° C., and a finish rolling temperature is controlled at 875˜945° C.

14. The manufacturing method according to claim 9, wherein in Step (3), a rolling reduction ratio in the rough rolling stage is controlled at more than 35%, and a rolling reduction ratio in the finish rolling stage is controlled at more than 55%.

15. The manufacturing method according to claim 9, wherein in Step (4), an initial cooling temperature for the primary cooling is (Ar3′+5)˜(Ar3′+45)° C., (M₉₀+5° C.)<a final cooling temperature<(Bₛ−15° C.), and a cooling rate is 2˜12° C./s.

16. The high-strength, high-hardness reinforced wear-resistant steel according to claim 2, wherein the mass percentage of each chemical element satisfies: C: 0.22˜0.31%, Si: 0.10˜0.80%, Mn: 1.00˜1.80%, Cr: 1.10˜2.20%, Al: 0.010˜0.080%; or the mass percentage of each chemical element satisfies: C: 0.23˜0.31%, Si: 0.15˜0.80%, Mn: 1.10˜1.80%, Cr: 1.10˜2.00%, Al: 0.015˜0.075%; or the mass percentage of each chemical element satisfies: C: 0.23˜0.30%, Si: 0.15˜0.65%, Mn: 1.15˜1.80%, Cr: 1.15˜2.00%, Al: 0.015˜0.070%.

17. The high-strength, high-hardness reinforced wear-resistant steel according to claim 4, wherein the mass percentage of the chemical elements has one or more of the following features: the content of C is 0.23˜0.28%; the content of Si is 0.15˜0.65%; the content of Mn is 1.05˜1.65%; the content of Cr is 1.25˜2.10%; and the content of Al is 0.035˜0.080%.

18. The high-strength, high-hardness reinforced wear-resistant steel according to claim 7, wherein the volume fraction of residual austenite is 5˜15%, and the volume fraction of martensite is 60˜90%.

19. The high-strength, high-hardness reinforced wear-resistant steel according to claim 18, wherein the volume fraction of residual austenite is 5.3˜12.0% or 5.5˜8.5%, and the volume fraction of martensite is 70˜88% or 77.5˜85.6%.

20. The high-strength, high-hardness reinforced wear-resistant steel according to claim 1, wherein the high-strength, high-hardness reinforced wear-resistant steel has a yield strength of 800˜1000 MPa or 830˜980 MPa, and/or a yield strength ratio of ≤0.75 or ≤0.70.
